(19) United States
(12) Patent Application Publication
(10) Pub. No.: US 2013/0313981 A1
(43) Pub. Date: Nov. 28, 2013

(54) PLASMA DISPLAY DEVICE

(71) Applicant: Takuya Shimomura, Hyogo (JP)

(72) Inventor: Takuya Shimomura, Hyogo (JP)

(73) Assignee: PANASONIC CORPORATION, Osaka (JP)

(21) Appl. No.: 13/983,531

(22) PCT Filed: Feb. 22, 2012
(86) PCT No.: PCT/JP2012/001191

§ 371 Date: Aug. 2, 2013

(30) Foreign Application Priority Data
Feb. 24, 2011 (JP) 2011-038067

(51) Int. Cl. H05B 41/30

(52) U.S. Cl. CPC H05B 41/30
USPC 315/169.4

(57) ABSTRACT

The number of components forming a scan electrode driver circuit is suppressed. For this purpose, a scan pulse generation circuit includes a first electric power supply for generating a positive voltage to be superimposed on the reference electric potential of the scan pulse generation circuit, high-voltage-side transistors for outputting the high-side voltage of the first electric power supply to scan electrodes, and low-voltage-side transistors for outputting the low-side voltage of the first electric power supply to the scan electrodes. A down-waveform generation circuit includes a second electric power supply for generating a positive voltage to be superimposed on the reference electric potential, and a Miller integration circuit that has one terminal connected to the high-voltage side of the second electric power supply and the other terminal connected to the ground electric potential. The down-waveform generation circuit generates a down-ramp waveform voltage falling to a negative voltage.

### TECHNICAL FIELD

The present invention relates to a plasma display apparatus that includes a plasma display panel of the AC surface discharge type.

### BACKGROUND ART

An AC surface discharge panel typically used as a plasma display panel (hereinafter, simply referred to as “panel”) has a large number of discharge cells that are formed between a front substrate and a rear substrate facing each other.

With the front substrate, a plurality of display electrode pairs, each formed of a scan electrode and a sustain electrode, is disposed on a front glass substrate parallel to each other. A dielectric layer and a protective layer are formed so as to cover the display electrode pairs.

With the rear substrate, a plurality of parallel data electrodes is formed on a rear glass substrate, and a dielectric layer is formed so as to cover the data electrodes. Further, a plurality of barrier ribs is formed on the dielectric layer parallel to the data electrodes. Phosphor layers are formed on the surface of the dielectric layer and on the side faces of the barrier ribs.

The front substrate and the rear substrate are opposed to each other and sealed together such that the display electrode pairs three-dimensionally intersect the data electrodes. The sealed inside discharge space is filled with a discharge gas containing xenon in a partial pressure ratio of 5%, for example. Discharge cells are formed in the parts where the display electrode pairs face the data electrodes. For the thus structured panel, a gas discharge generates ultraviolet rays in each discharge cell. These ultraviolet rays excite the red (R), green (G), and blue (B) phosphors such that the phosphors of the respective colors emit light for color image display.

A subfield method is generally used as a method for displaying an image in the image display area of the panel by combining binary control of light emission and no light emission in the respective discharge cells.

In the subfield method, one field is divided into a plurality of subfields having different emission luminances. In each discharge cell, light emission and no light emission are controlled in each subfield in combination corresponding to a desired gradation value. With this control, the respective discharge cells are lit such that the emission luminances in one field are at desired gradation values. Thus, an image formed of various combinations of gradation values is displayed in the image display area of the panel.

In the subfield method, each subfield has an initializing period, an address period, and a sustain period.

In the initializing periods, an initializing operation is performed so as to apply an initializing waveform to the respective scan electrodes and cause an initializing discharge in the respective discharge cells. This initializing operation forms wall charge necessary for the subsequent address operation in the respective discharge cells and generates priming particles (excitation particles for causing a discharge) for causing a stable address discharge.

In the address periods, a scan pulse is sequentially applied to the scan electrodes, and an address pulse in response to a signal of an image to be displayed is applied selectively to the data electrodes. Thus, an address discharge is caused between the scan electrodes and the data electrodes so as to form wall charge in the discharge cells to be lit (hereinafter, these operations being also generically referred to as “addressing”).

In each sustain period, a number of sustain pulses based on a luminance weight predetermined for the subfield are applied alternately to display electrode pairs, each formed of a scan electrode and a sustain electrode. This operation causes a sustain discharge in the discharge cells having undergone the address discharge, thus causing the phosphor layers of the discharge cells to emit light. (Hereinafter, causing a discharge cell to be lit by a sustain discharge is also denoted as “lighting”, and causing a discharge cell not to be lit as “non-lighting”). Thereby, in each subfield, the respective discharge cells are lit at luminances corresponding to the luminance weight. In this manner, the respective discharge cells of the panel are lit at the luminances corresponding to the gradation values of the image signals. Thus, an image is displayed in the image display area of the panel.

In the above driving method, a weak initializing discharge is caused in the initializing periods. Further, an erasing discharge is caused after the last sustain pulse is generated in the sustain periods. For this purpose, it is necessary to generate a ramp waveform voltage gently rising or falling and to apply the ramp waveform voltage to one or both of electrodes of each display electrode pair.

In order to generate this ramp waveform voltage in a stable manner, a Miller integration circuit is mainly used (see Patent Literature 1, for example).

In the plasma display apparatus including a high-definition large panel, the voltage applied to each electrode tends to be relatively high. Thus, the maximum voltage tends to be higher in the rising ramp waveform voltage, and the minimum voltage tends to be lower in the falling ramp waveform voltage.

With these tendencies, the configurations of the circuits for driving electrodes become more complicated. This increases the number of components forming the circuits and the area of the substrate on which the circuits are mounted.

Therefore, in a plasma display apparatus including a high-definition large panel, there is a demand for reducing the number of components forming the circuits, e.g. a scan electrode driver circuit of simple configuration.

### CITATION LIST

### Patent Literature

PTL1

Japanese Patent Unexamined Publication No. H11-133914

### SUMMARY OF THE INVENTION

A plasma display apparatus includes a panel that has a plurality of discharge cells each including a scan electrode, and a scan electrode driver circuit for applying a driving voltage waveform to the scan electrodes. The plasma display apparatus displays an image on the panel such that one field is formed of a plurality of subfields each having an initializing period, an address period, and a sustain period. In this plasma display apparatus, the scan electrode driver circuit includes a down-waveform generation circuit for generating a down-ramp waveform voltage to be applied to the scan electrodes in the initializing periods, and a scan pulse generation circuit for generating a scan pulse to be applied to the scan electrodes in the address periods. The scan pulse generation circuit includes a first electric power supply for generating a positive voltage to be superimposed on the reference electric potential of the scan pulse generation circuit, a plurality of high-voltage-side transistors for outputting the high-side voltage of the first electric power supply to the plurality of scan electrodes, and a plurality of low-voltage-side transistors for outputting the low-side voltage of the first electric power supply to the plurality of scan electrodes. The down-waveform generation circuit includes a second electric power supply for generating a positive voltage to be superimposed on the reference electric potential, and a Miller integration circuit that has one terminal connected to the high-voltage side of the second electric power supply and the other terminal connected to the ground electric potential. The down-waveform generation circuit generates a down-ramp waveform voltage falling to a negative voltage.

This configuration can reduce the number of components forming the scan electrode driver circuit in the plasma display apparatus. Thus, the scan electrode driver circuit can be implemented with a simple configuration.

In the plasma display apparatus, the scan electrode driver circuit includes a resistive divider circuit and a comparator circuit. The resistive divider circuit divides the output voltage of one of the first electric power supply and the second electric power supply having a higher output voltage by resistance so as to generate the voltage equal to the voltage of the electric power supply that has a lower output voltage. The output terminal of the electric power supply having the lower output voltage is connected, via a blocking diode, to the node whose voltage is equal to the voltage of the electric power supply having the lower output voltage. The comparator circuit compares the voltage at the node or the voltage obtained by dividing the voltage at the node by resistance with a predetermined threshold voltage so as to detect the overvoltage of the first electric power supply or the second electric power supply.

### BRIEF DESCRIPTION OF DRAWINGS

FIG. 1 is an exploded perspective view showing a structure of a panel for use in a plasma display apparatus in accordance with an exemplary embodiment of the present invention.

FIG. 2 is an electrode array diagram of the panel for use in the plasma display apparatus in accordance with the exemplary embodiment.

FIG. 3 is a diagram schematically showing an example of circuit blocks forming the plasma display apparatus in accordance with the exemplary embodiment.

FIG. 4 is a diagram schematically showing a configuration example of a scan electrode driver circuit of the plasma display apparatus in accordance with the exemplary embodiment.

FIG. 5 is a chart schematically showing an example of driving voltage waveforms applied to the respective electrodes of the panel for use in the plasma display apparatus in accordance with the exemplary embodiment.

FIG. 6 is a diagram schematically showing a configuration example of an overvoltage detection circuit in the scan electrode driver circuit of the plasma display apparatus in accordance with the exemplary embodiment.

### DESCRIPTION OF EMBODIMENT

Hereinafter, a description is provided for a plasma display apparatus in accordance with an exemplary embodiment of the present invention with reference to the accompanying drawings.

### Exemplary Embodiment

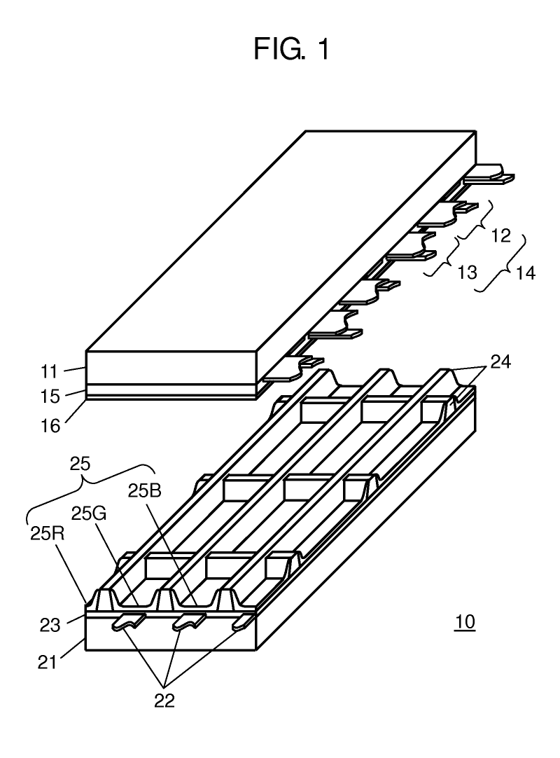

FIG. 1 is an exploded perspective view showing a structure of panel 10 for use in the plasma display apparatus in accordance with the exemplary embodiment of the present invention.

A plurality of display electrode pairs 14, each formed of scan electrode 12 and sustain electrode 13, is arranged on glass front substrate 11. Dielectric layer 15 is formed so as to cover scan electrodes 12 and sustain electrodes 13. Protective layer 16 is formed over dielectric layer 15.

In order to lower a discharge start voltage in discharge cells, protective layer 16 is formed of a material predominantly composed of magnesium oxide (MgO). MgO has proven performance as a panel material, and has a large secondary electron emission coefficient and excellent durability when neon (Ne)-xenon (Xe) gas is sealed.

Protective layer 16 may be formed of one layer or a plurality of layers. Further, particles may be present on the layers.

A plurality of data electrodes 22 is arranged on rear substrate 21. Dielectric layer 23 is formed so as to cover data electrodes 22, and mesh barrier ribs 24 are formed on the dielectric layer. On the side faces of barrier ribs 24 and on dielectric layer 23, phosphor layer 25R for emitting red (R) light, phosphor layer 25G for emitting green (G) light, and phosphor layer 25B for emitting blue (B) light are formed. Hereinafter, phosphor layer 25R, phosphor layer 25G, and phosphor layer 25B are also collectively denoted as phosphor layers 25.

Front substrate 11 and rear substrate 21 face each other such that display electrode pairs 14 intersect data electrodes 22 with a small space sandwiched between the electrodes. Thereby, a discharge space is formed in the gap between front substrate 11 and rear substrate 21. The outer peripheries of the substrates are sealed with a sealing material, such as glass frit. As a discharge gas, a mixture gas of neon and xenon, for example, is sealed into the discharge space.

The discharge space is partitioned into a plurality of compartments by barrier ribs 24. Discharge cells that constitute pixels are formed in the intersecting parts of display electrode pairs 14 and data electrodes 22.

Discharge in these discharge cells and light emission of phosphor layers 25 in these discharge cells (lighting of the discharge cells) allow display of a color image on panel 10.

In panel 10, one pixel is formed of three consecutive discharge cells arranged in the extending direction of display electrode pair 14. These three discharge cells are a discharge cell having phosphor layer 25R and emitting red (R) light (a red discharge cell), a discharge cell having phosphor layer 25G and emitting green (G) light (a green discharge cell), and a discharge cell having phosphor layer 25B and emitting blue (B) light (a blue discharge cell).

The structure of panel 10 is not limited to the above. The panel may include barrier ribs in a stripe pattern, for example.

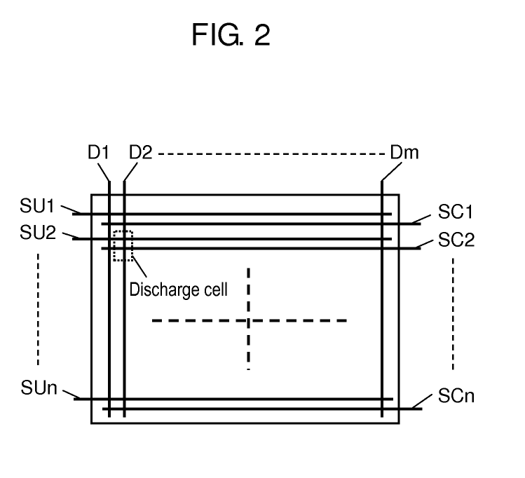

FIG. 2 is an electrode array diagram of panel 10 for use in the plasma display apparatus in accordance with the exemplary embodiment of the present invention.

Panel 10 has n scan electrode SC1-scan electrode SCn (scan electrodes 12 in FIG. 1) and n sustain electrode SU1-sustain electrode SUn (sustain electrodes 13 in FIG. 1) extended in the horizontal direction (i.e. row direction and line direction), and m data electrode D1-data electrode Dm (data electrodes 22 in FIG. 1) extended in the vertical direction (i.e. column direction).

A discharge cell is formed in the part where a pair of scan electrode SCi (i=1−n) and sustain electrode SUi intersects one data electrode Dj (j=1−m). That is, one display electrode pair 14 has m discharge cells, which form m/3 pixels. Then, m×n discharge cells are formed in the discharge space. The area having m×n discharge cells is the image display area of panel 10. For instance, in a panel having 1920×1080 pixels, m=1920×3 and n=1080.

Next, a description is provided for a configuration of the plasma display apparatus in accordance with the exemplary embodiment.

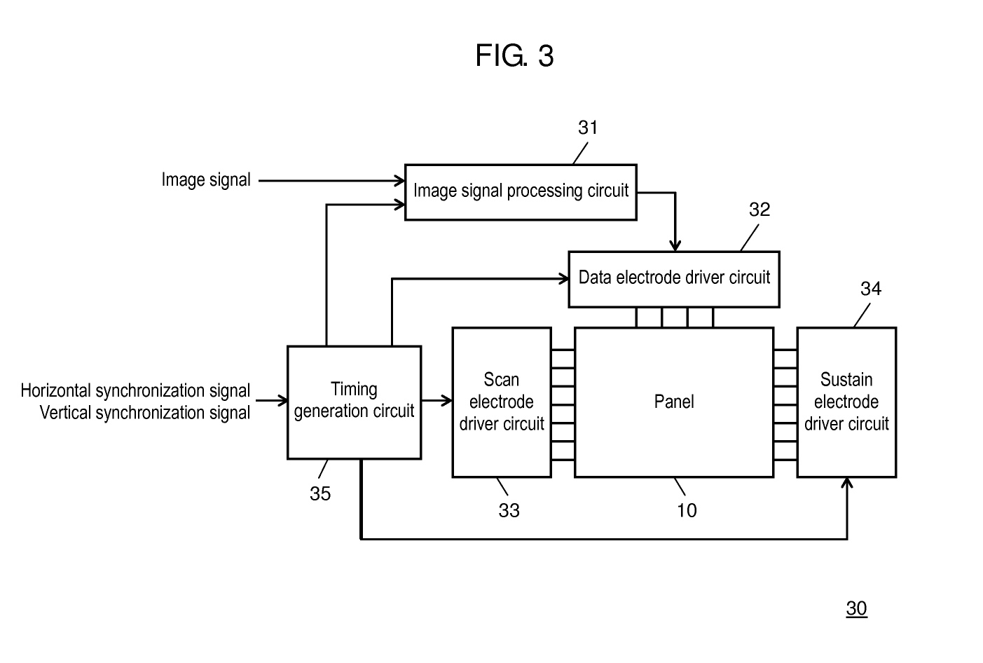

FIG. 3 is a diagram schematically showing an example of circuit blocks forming plasma display apparatus 30 in accordance with the exemplary embodiment of the present invention.

Plasma display apparatus 30 includes panel 10 and driver circuits for driving panel 10. The driver circuits include image signal processing circuit 31, data electrode driver circuit 32, scan electrode driver circuit 33, sustain electrode driver circuit 34, timing generation circuit 35, and electric power supply circuits (not shown) for supplying electric power necessary for each circuit block.

The image signals input to image signal processing circuit 31 are a red image signal, a green image signal, and a blue image signal. Based on the red image signal, the green image signal, and the blue image signal, image signal processing circuit 31 sets red, green, and blue gradation values (gradation values represented in one field) for the respective discharge cells. When input image signals include a luminance signal (Y signal) and a chroma signal (C signal, R-Y signal and B-Y signal, u signal and v signal, or the like), image signal processing circuit 31 calculates a red image signal, a green image signal, and a blue image signal based on the luminance signal and the chroma signal, and thereafter sets red, green, and blue gradation values for the respective discharge cells. Then, the image signal processing circuit converts the red, green, and blue gradation values set for the respective discharge cells into image data representing light emission and no light emission in each subfield (data where light emission and no light emission correspond to the digital signals “1” and “0”, respectively) and outputs the converted data. That is, image signal processing circuit 31 converts a red image signal, a green image signal, and a blue image signal into red image data, green image data, and blue image data, respectively, and outputs the converted data.

Timing generation circuit 35 generates various timing signals for controlling the operation of each circuit block in response to a horizontal synchronization signal and a vertical synchronization signal. Then, the timing generation circuit supplies the generated timing signals to each circuit block (data electrode driver circuit 32, scan electrode driver circuit 33, sustain electrode driver circuit 34, image signal processing circuit 31, or the like).

Scan electrode driver circuit 33 has an up-waveform generation circuit, a down-waveform generation circuit, a sustain pulse generation circuit, and a scan pulse generation circuit (not shown in FIG. 3). In response to timing signals supplied from timing generation circuit 35, the scan electrode driver circuit generates driving voltage waveforms and applies the driving voltage waveforms to each of scan electrode SC1-scan electrode SCn. In response to timing signals, the up-waveform generation circuit and the down-waveform generation circuit generate initializing waveforms to be applied to scan electrode SC1-scan electrode SCn in the initializing periods. In response to a timing signal, the sustain pulse generation circuit generates sustain pulses to be applied to scan electrode SC1-scan electrode SCn in the sustain periods. The scan pulse generation circuit has a plurality of scan electrode driver ICs (scan ICs) and, in response to a timing signal, generates scan pulses to be applied to scan electrode SC1-scan electrode SCn in the address periods.

Sustain electrode driver circuit 34 has a sustain pulse generation circuit and a circuit for generating voltage Ve (not shown in FIG. 3). The sustain electrode driver circuit generates driving voltage waveforms in response to a timing signal supplied from timing generation circuit 35, and applies the waveforms to each of sustain electrode SU1-sustain electrode SUn. In the sustain periods, the sustain electrode driver circuit generates sustain pulses in response to a timing signal, and applies the sustain pulses to sustain electrode SU1-sustain electrode SUn. In the initializing periods and the address periods, the sustain electrode driver circuit generates voltage Ve in response to a timing signal, and applies the voltage to sustain electrode SU1-sustain electrode SUn.

Data electrode driver circuit 32 generates an address pulse corresponding to each of data electrode D1-data electrode Dm, in response to the image data of respective colors output from image signal processing circuit 31 and timing signals supplied from timing generation circuit 35. Data electrode driver circuit 32 applies the address pulse to each of data electrode D1-data electrode Dm in the address periods.

Next, a description is provided for the scan electrode driver circuit included in plasma display apparatus 30.

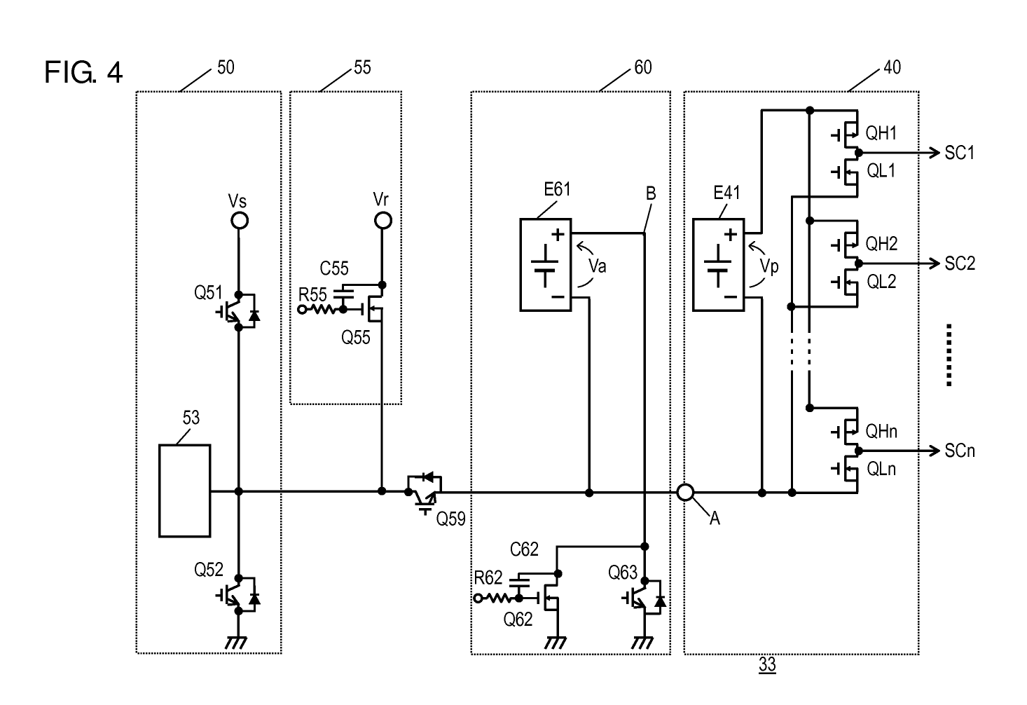

FIG. 4 is a diagram schematically showing a configuration example of scan electrode driver circuit 33 of plasma display apparatus 30 in accordance with the exemplary embodiment of the present invention.

Scan electrode driver circuit 33 has an overvoltage detection circuit that includes a resistive divider circuit and a comparator circuit as described later. In FIG. 4, the overvoltage detection circuit is omitted.

Scan electrode driver circuit 33 includes scan pulse generation circuit 40, sustain pulse generation circuit 50, up-waveform generation circuit 55, down-waveform generation circuit 60, and transistor Q59.

Transistor Q59 is a separation switch. For instance, when down-waveform generation circuit 60 is operated, transistor Q59 is turned off. Thereby, up-waveform generation circuit 55 and sustain pulse generation circuit 50 are electrically separated from down-waveform generation circuit 60 such that current backflow is prevented.

Scan pulse generation circuit 40 includes first electric power supply E41, high-voltage-side transistor QH1 through high-voltage-side transistor QHn, and low-voltage-side transistor QL1 through low-voltage-side transistor QLn. Hereinafter, high-voltage-side transistor QH1 through high-voltage-side transistor QHn are denoted as “transistor QH1-transistor QHn”; low-voltage-side transistor QL1 through low-voltage-side transistor QLn are denoted as “transistor QL1-transistor QLn”.

The electric potential at the node denoted as “A” in FIG. 4 is the reference electric potential of scan pulse generation circuit 40. Hereinafter, this node is denoted as “node A”.

First electric power supply E41 superimposes positive voltage Vp on the voltage at node A, which is the reference electric potential of scan pulse generation circuit 40. In the exemplary embodiment, first electric power supply E41 is formed of a transformer and a rectification circuit. However, first electric power supply E41 may be an electric power supply circuit of another configuration.

Transistor QH1-transistor QHn are connected to the terminal of first electric power supply E41 on the high voltage side, and apply the high-side voltage of first electric power supply E41 (i.e. the voltage obtained by superimposing positive voltage Vp on the voltage at node A) to scan electrode SC1-scan electrode SCn, respectively.

Transistor QL1-transistor QLn are connected to the terminal of first electric power supply E41 on the low voltage side, and apply the low-side voltage of first electric power supply E41 (i.e. the voltage at node A) to scan electrode SC1-scan electrode SCn, respectively.

In response to a timing signal supplied from timing generation circuit 35, scan pulse generation circuit 40 generates scan pulses by switching on and off transistor QH1-transistor QHn and transistor QL1-transistor QLn, and applies the scan pulses to scan electrode SC1-scan electrode SCn in the address periods.

Sustain pulse generation circuit 50 includes transistor Q51, transistor Q52, and electric power recovery part 53.

Electric power recovery part 53 includes an inductor and a power recovery capacitor. The electric power recovery part recovers the electric power stored in the interelectrode capacitance of panel 10 into the power recovery capacitor by LC resonance between the inductor and the interelectrode capacitance of panel 10. The electric power stored in the power recovery capacitor is reused by LC resonance for generating sustain pulses.

Transistor Q51 clamps the voltage at node A to voltage Vs on the high voltage side of the sustain pulse. Transistor Q52 clamps the voltage at node A to voltage 0 (V) on the low voltage side of the sustain pulse.

In response to timing signals supplied from timing generation circuit 35, sustain pulse generation circuit 50 switches and operates transistor Q51, transistor Q52, and electric power recovery part 53 in the sustain periods. By changing the electric potential at node A between voltage Vs and voltage 0 (V) in this manner, sustain pulses are generated.

Examples of each of the transistors used include an insulated gate bipolar transistor (IGBT) and a field effect transistor (FET).

In the exemplary embodiment, insulated gate bipolar transistors are used as transistor Q51, transistor Q52, and transistor Q59. As shown in FIG. 4, a diode is connected parallel to each transistor so as to bypass the current flowing from the emitter to the collector (current that flows in the backward direction of the forward current flowing in normal operation). This diode is provided to protect each insulated gate bipolar transistor from the backward current.

When a field effect transistor is used as each transistor, this diode can be omitted. This is because the diode (body diode) included in the field effect transistor can bypass the backward current flowing from the emitter to the collector.

Up-waveform generation circuit 55 is a Miller integration circuit formed of transistor Q55, capacitor C55, and resistor R55. This Miller integration circuit is connected to the electric power supply at voltage Vr. Up-waveform generation circuit 55 gently raises the voltage at node A toward voltage Vr. Thus, this Miller integration circuit generates an up-ramp waveform voltage that gently rises toward voltage Vr.

Down-waveform generation circuit 60 includes second electric power supply E61, a Miller integration circuit, and transistor Q63.

Second electric power supply E61 superimposes positive voltage Va on the voltage at node A, which is the reference electric potential of scan pulse generation circuit 40. In the exemplary embodiment, second electric power supply E61 is formed of a transformer and a rectification circuit. However, second electric power supply E61 may be an electric power supply circuit of another configuration.

The Miller integration circuit is formed of transistor Q62, capacitor C62, and resistor R62. This Miller integration circuit has one terminal connected to the terminal of second electric power supply E61 on the high voltage side and the other terminal connected to the ground electric potential (voltage 0 (V)). Hereinafter, the terminal of second electric power supply E61 on the high voltage side is denoted as “node B”.

This Miller integration circuit gently lowers the voltage at node A toward negative voltage (−Va) by gently lowering the voltage at node B toward voltage 0 (V). Thus, this Miller integration circuit generates a down-ramp waveform voltage that gently falls toward negative voltage (−Va).

Transistor Q63 clamps node B of second electric power supply E61 to the ground electric potential (voltage 0 (V)). Thereby, the voltage at node A is clamped to negative voltage (−Va).

In the address periods, for example, the voltage at node A is clamped to negative voltage (−Va) by turning on transistor Q63. Thereby, transistor QL1-transistor QLn can be applied with negative voltage (−Va), and transistor QH1-transistor QHn can be applied with voltage Vc obtained by superimposing voltage Vp on negative voltage (−Va). To scan electrode SCi to be applied with a scan pulse, a scan pulse at negative voltage (−Va) can be applied via switching element QLi by turning off switching element QHi and turning on switching element QLi. To scan electrode SCh to be applied with no scan pulse (h=1−n except i), voltage Vc can be applied via switching element QHh by turning off switching element QLh and turning on switching element QHh.

In this manner, scan electrode driver circuit 33 is capable of setting the voltage at node A, i.e. the reference electric potential of scan pulse generation circuit 40, to positive voltage Vs, voltage 0 (V), or negative voltage (−Va). Further, the scan electrode driver circuit is capable of generating an up-ramp waveform voltage by raising the voltage at node A toward voltage Vr, and a down-ramp waveform voltage by lowering the voltage at node A toward negative voltage (−Va).

Next, driving voltage waveforms for driving panel 10 and the operation thereof are outlined.

The plasma display apparatus of the exemplary embodiment drives panel 10 by a subfield method. In the subfield method, one field in an image signal is divided into a plurality of subfields along a temporal axis, and a luminance weight is set for each subfield. Thus, each field has a plurality of subfields having different luminance weights.

Each subfield has initializing period Ti, address period Tw, and sustain period Ts. In response to image signals, light emission and no light emission in the respective discharge cells are controlled in each subfield. That is, a plurality of gradations in response to image signals is displayed on panel 10 by combining lighting subfields and non-lighting subfields in response to image signals.

In each initializing period Ti, an initializing operation is performed so as to cause an initializing discharge in the discharge cells and form wall charge necessary for an address discharge in subsequent address period Tw on the respective electrodes.

The initializing operations include the following two types: a “forced initializing operation” for forcedly causing an initializing discharge in all the discharge cells regardless of the operation in the immediately preceding subfield; and a “selective initializing operation” for selectively causing an initializing discharge only in the discharge cells having undergone an address discharge in the address period of the immediately preceding subfield. In the forced initializing operation, a rising ramp waveform voltage and a falling ramp waveform voltage are applied to scan electrode SC1-scan electrode SCn so as to cause an initializing discharge in the discharge cells. In the selective initializing operation, a falling ramp waveform voltage is applied to scan electrode SC1-scan electrode SCn so as to cause an initializing discharge selectively in the discharge cells.

The exemplary embodiment describes the following structure. In the initializing period of one subfield among the plurality of subfields forming one field, a forced initializing operation is performed in all the discharge cells. In the initializing periods of the other subfields, a selective initializing operation is performed in all the discharge cells. However, the present invention is not limited to this structure. For example, the forced initializing operation may be performed once in a plurality of fields. Alternatively, only one subfield having an initializing period may be set in a plurality of subfields, or only one subfield having an initializing period may be set in a plurality of fields.

Hereinafter, initializing period Ti where a forced initializing operation is performed is referred to as “forced initializing period” and the subfield including a forced initializing period is referred to as “forced initializing subfield”. Initializing period Ti where a selective initializing operation is performed is referred to as “selective initializing period” and the subfield including a selective initializing period is referred to as “selective initializing subfield”.

In the exemplary embodiment, subfield SF1 is set as a forced initializing subfield, and the other subfields (subfield SF2 and subfields thereafter) are set as selective initializing subfields. However, in the present invention, the subfields set as the forced initializing subfield and the selective initializing subfields are not limited to the above subfields. The subfield structure may be switched in response to an image signal, for example.

In each address period Tw, a scan pulse is applied to scan electrode SC1-scan electrode SCn and an address pulse is applied selectively to data electrode D1-data electrode Dm so as to cause an address discharge selectively in the discharge cells to be lit. Thus, an address operation is performed so as to form wall charge for causing a sustain discharge in subsequent sustain period Ts in the discharge cells.

In each sustain period Ts, a sustain operation is performed in the following manner. Scan electrode SC1-scan electrode SCn and sustain electrode SU1-sustain electrode SUn are alternately applied with sustain pulses equal in number to the luminance weight set for the subfield multiplied by a predetermined proportionality factor. Thus, a sustain discharge is caused in the discharge cells having undergone an address discharge in the immediately preceding address period so as to light the discharge cells. This proportionality factor is a luminance magnification.

The luminance weight represents a ratio of the magnitude of the luminance to be displayed in each subfield. In the sustain period of each subfield, sustain pulses corresponding in number to the luminance weight are generated. For instance, the luminance of a light emission in a subfield having the luminance weight “8” is approximately eight times as high as that in a subfield having the luminance weight “1”, and is approximately four times as high as that in a subfield having the luminance weight “2”. Thus, for instance, when light emission occurs in a subfield having the luminance weight “8” and in a subfield having the luminance weight “2”, the discharge cell can emit light at a luminance corresponding to the gradation value “10”.

Light emission is caused selectively in each subfield by controlling light emission and no light emission in the respective discharge cells in each subfield in combination in response to image signals. Thereby, the respective discharge cells are lit with various gradation values. That is, gradation values in response to image signals can be displayed in the respective discharge cells and an image in response to image signals can be displayed on panel 10.

The exemplary embodiment describes the following example. One field is formed of eight subfields, i.e. subfield SF1 through subfield SF8, and subfield SF1 through subfield SF8 have respective luminance weights of 1, 2, 4, 8, 16, 32, 64, and 128. Subfield SF1 is set as a forced initializing subfield and subfield SF2 through subfield SF8 are set as selective initializing subfields.

However, in the present invention, the number of subfields forming one field, the frequency of forced initializing operations, the luminance weight of each subfield or the like is not limited to the above numerical value. The subfield structure may be switched in response to an image signal, for example.

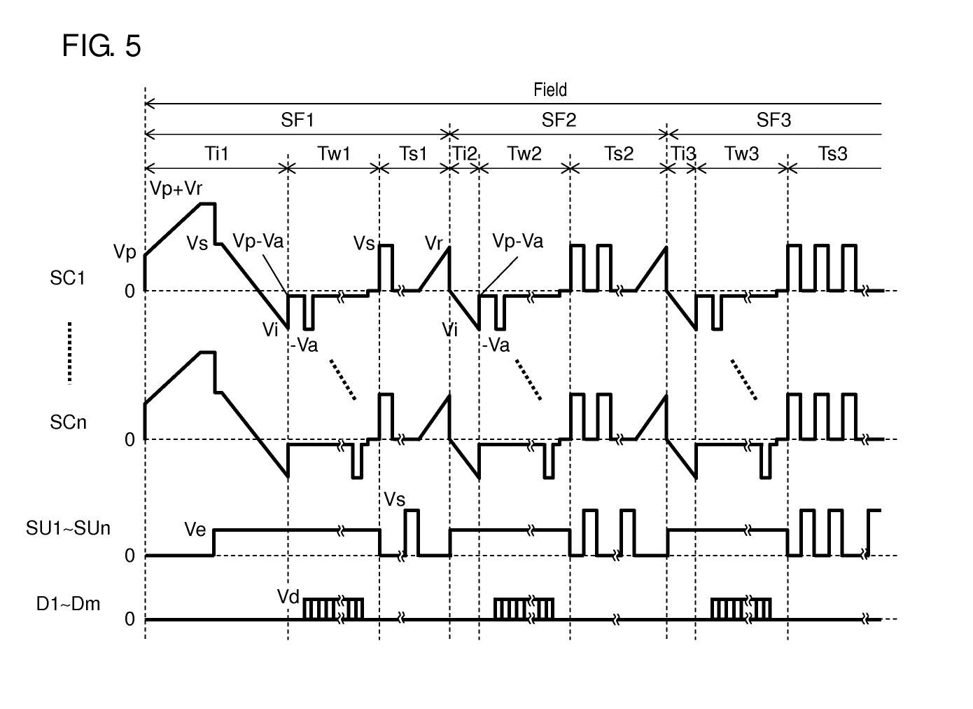

FIG. 5 is a chart schematically showing an example of driving voltage waveforms applied to the respective electrodes of panel 10 for use in plasma display apparatus 30 in accordance with the exemplary embodiment of the present invention.

FIG. 5 shows driving voltage waveforms applied to the following electrodes: scan electrode SC1 to undergo an address operation first in the address periods; scan electrode SCn (e.g. scan electrode SC1080) to undergo an address operation last in the address periods; data electrode D1-data electrode Dm; and sustain electrode SU1-sustain electrode SUn. Scan electrode SCi, sustain electrode SUi, and data electrode Dk in the following description show the electrodes selected among the respective electrodes based on image data (data representing light emission and no light emission in each subfield).

FIG. 5 shows subfield SF1, i.e. a forced initializing subfield, and subfield SF2 and subfield SF3, i.e. selective initializing subfields. The waveform shape of the driving voltage applied to scan electrode SC1-scan electrode SCn in the initializing period of subfield SF1 is different from those in subfield SF2 and subfields thereafter.

Although subfield SF4 and subfields thereafter are not shown, the respective subfields except subfield SF1 are selective initializing subfields and thus substantially the same driving voltage waveforms except for the numbers of sustain pulses are generated in the respective periods of these subfields.

First, a description is provided for subfield SF1, a forced initializing subfield.

In the first half of initializing period Ti1 of subfield SF1, where a forced initializing operation is performed, voltage 0 (V) is applied to data electrode D1-data electrode Dm and sustain electrode SU1-sustain electrode SUn. Scan electrode SC1-scan electrode SCn are applied with voltage 0 (V) and then with voltage Vp. Thereafter, scan electrode SC1-scan electrode SCn are applied with an up-ramp waveform voltage that gently rises from voltage Vp to (voltage Vp+voltage Vr). At this time, voltage Vp is set to a voltage lower than a discharge start voltage with respect to sustain electrode SU1-sustain electrode SUn. (Voltage Vp+voltage Vr) is set to a voltage exceeding the discharge start voltage with respect to sustain electrode SU1-sustain electrode SUn.

A description is provided for the operation of scan electrode driver circuit 33 when the up-ramp waveform voltage is applied to scan electrode SC1-scan electrode SCn.

First, transistor Q52 and transistor Q59 are turned on so as to clamp the voltage at node A to voltage 0 (V). Next, transistor QH1-transistor QHn are turned on and transistor QL1-transistor QLn are turned off such that scan electrode SC1-scan electrode SCn are applied with the voltage obtained by superimposing voltage Vp on the voltage at node A. Thus, voltage Vp is applied to scan electrode SC1-scan electrode SCn.

Next, transistor Q52 is turned off. By feeding a current to transistor Q55 through resistor R55, the Miller integration circuit in up-waveform generation circuit 55 is operated. With this operation, the voltage at node A gently rises from voltage 0 (V) toward voltage Vr. Scan electrode SC1-scan electrode SCn are applied with the voltage obtained by superimposing voltage Vp on the voltage at node A, via transistor QH1-transistor QHn, respectively. Therefore, scan electrode SC1-scan electrode SCn can be applied with an up-ramp waveform voltage that gently rises from voltage Vp toward (voltage Vp+voltage Vr).

The above description shows the operation of scan electrode driver circuit 33 when the up-ramp waveform voltage is applied to scan electrode SC1-scan electrode SCn.

While this up-ramp waveform voltage is rising, a weak initializing discharge continuously occurs between scan electrode SC1-scan electrode SCn and sustain electrode SU1-sustain electrode SUn, and between scan electrode SC1-scan electrode SCn and data electrode D1-data electrode Dm in the respective discharge cells. Then, negative wall voltage accumulates on scan electrode SC1-scan electrode SCn; positive wall voltage accumulates on data electrode D1-data electrode Dm and sustain electrode SU1-sustain electrode SUn. This wall voltage on the electrodes means the voltage generated by the wall charge that is accumulated on the dielectric layers covering the electrodes, the protective layer, the phosphor layers, or the like.

After the voltage applied to scan electrode SC1-scan electrode SCn has reached (voltage Vp+voltage Vr), the voltage applied to scan electrode SC1-scan electrode SCn is lowered to voltage Vs.

In the second half of the initializing period of subfield SF1, sustain electrode SU1-sustain electrode SUn are applied with positive voltage Ve, which is lower than voltage Vs. Data electrode D1-data electrode Dm are continuously kept at voltage 0 (V). Scan electrode SC1-scan electrode SCn are applied with a down-ramp waveform voltage that gently falls from voltage Vs to negative voltage Vi. Voltage Vs is set to a voltage lower than the discharge start voltage, and voltage Vi is set to a voltage exceeding the discharge start voltage with respect to sustain electrode SU1-sustain electrode SUn.

A description is provided for the operation of scan electrode driver circuit 33 when the down-ramp waveform voltage is applied to scan electrode SC1-scan electrode SCn.

First, by turning off transistor Q55, the operation of the Miller integration circuit in up-waveform generation circuit 55 is stopped. Next, by turning on transistor Q51 and transistor Q59, the voltage at node A is clamped to voltage Vs. Subsequently, transistor QH1-transistor QHn are turned off and transistor QL1-transistor QLn are turned on. Thereby, scan electrode SC1-scan electrode SCn are applied with voltage Vs, i.e. the voltage at node A.

Next, transistor Q51 and transistor Q59 are turned off. By feeding a current to transistor Q62 through resistor R62, the Miller integration circuit in down-waveform generation circuit 60 is operated. With this operation, the voltage at node B gently falls from (voltage Vs+voltage Va) toward voltage 0 (V). The voltage at node A gently falls from voltage Vs toward negative voltage (−Va). The voltage at node A is applied to scan electrode SC1-scan electrode SCn via transistor QL1-transistor QLn, respectively. Therefore, scan electrode SC1-scan electrode SCn can be applied with a down-ramp waveform voltage that gently falls from voltage Vs toward negative voltage (−Va).

The above description shows the operation of scan electrode driver circuit 33 when the down-ramp waveform voltage is applied to scan electrode SC1-scan electrode SCn.

While this down-ramp waveform voltage is applied to scan electrode SC1-scan electrode SCn, a weak initializing discharge occurs again between scan electrode SC1-scan electrode SCn and sustain electrode SU1-sustain electrode SUn, and between scan electrode SC1-scan electrode SCn and data electrode D1-data electrode Dm in the respective discharge cells. This weak discharge reduces the negative wall voltage on scan electrode SC1-scan electrode SCn, the positive wall voltage on sustain electrode SU1-sustain electrode SUn, and adjusts the positive wall voltage on data electrode D1-data electrode Dm to a voltage suitable for the address operation in the address period.

After the down-ramp waveform voltage applied to scan electrode SC1-scan electrode SCn has reached voltage Vi, the voltage drop of the down-ramp waveform voltage is stopped. This is intended for fine adjustment of the wall voltage in the discharge cells.

The above voltage waveform is a forced initializing waveform for causing an initializing discharge in the discharge cells regardless of the operation in the immediately preceding subfield. The operation of applying the forced initializing waveform to scan electrode SC1-scan electrode SCn is a forced initializing operation.

Thus, the forced initializing operation in the initializing period of the forced initializing subfield (subfield SF1) is completed. In the initializing period of the forced initializing subfield, an initializing operation is caused forcedly in all the discharge cells in the image display area of panel 10 so as to form wall charge necessary for the address discharge to be caused in subsequent address period Tw1.

In address period Tw1 of subfield SF1, sustain electrode SU1-sustain electrode SUn are applied with voltage Ve, data electrode D1-data electrode Dm are applied with voltage 0 (V), and scan electrode SC1-scan electrode SCn are applied with (voltage Vp−voltage Va).

A description is provided for the operation of scan electrode driver circuit 33 when scan electrode SC1-scan electrode SCn are applied with (voltage Vp−voltage Va).

First, by turning on transistor Q63, the voltage at node B is clamped to voltage 0 (V). Thereby, the voltage at node A is clamped to negative voltage (−Va).

Next, transistor QH1-transistor QHn are turned on and transistor QL1-transistor QLn are turned off. Thereby, scan electrode SC1-scan electrode SCn are applied with a voltage obtained by superimposing voltage Vp on negative voltage (−Va), i.e. the voltage at node A. Thus, scan electrode SC1-scan electrode SCn are applied with (voltage Vp−voltage Va).

The above description shows the operation of scan electrode driver circuit 33 when (voltage Vp−voltage Va) is applied to scan electrode SC1-scan electrode SCn.

Next, a negative scan pulse at negative voltage (−Va) is applied to scan electrode SC1 in the first position from the top (first line). At the same time, a positive address pulse at positive voltage Vd is applied to data electrode Dk of the discharge cell to be lit in the first line among data electrode D1-data electrode Dm.

In order to apply negative voltage (−Va) to scan electrode SC1, it is only necessary to turn off transistor QH1 and turn on transistor QL1.

In the discharge cell in the intersecting part of data electrode Dk applied with address pulse voltage Vd and scan electrode SC1 applied with scan pulse voltage Va, the voltage difference between data electrode Dk and scan electrode SC1 exceeds the discharge start voltage, and a discharge occurs between data electrode Dk and scan electrode SC1.

Since voltage Ve is applied to sustain electrode SU1-sustain electrode SUn, the discharge caused between data electrode Dk and scan electrode SC1 induces a discharge between the areas of sustain electrode SU1 and scan electrode SC1 intersecting data electrode Dk. Thus, an address discharge occurs in the discharge cell applied with scan pulse voltage Va and address pulse voltage Vd at the same time (discharge cell to be lit).

In the discharge cell where an address discharge has occurred, positive wall voltage accumulates on scan electrode SC1, negative wall voltage accumulates on sustain electrode SU1, and negative wall voltage also accumulates on data electrode Dk.

Subsequently, by turning on transistor QH1 and turning off transistor QL1, the voltage applied to scan electrode SC1 is returned from voltage (−Va) to (voltage Vp−voltage Va). Thus, the address operation in the discharge cells in the first line is completed.

In the discharge cell including data electrode Dh applied with no address pulse (data electrode Dh being a data electrode except data electrode Dk among data electrode D1-data electrode Dm), the voltage in the intersecting part of data electrode Dh and scan electrode SC1 does not exceed the discharge start voltage. Thus, in the discharge cell, no address discharge occurs and the wall voltage after the completion of the initializing period is maintained.

Next, a scan pulse at negative voltage (−Va) is applied to scan electrode SC2 in the second position from the top (second line). At the same time, an address pulse at voltage Vd is applied to data electrode Dk corresponding to the discharge cell to be lit in the second line.

In order to apply negative voltage (−Va) to scan electrode SC2, it is only necessary to turn off transistor QH2 and turn on transistor QL2.

With this operation, in the discharge cells in the second line applied with a scan pulse and an address pulse at the same time, an address discharge occurs. Thus, an address operation is performed in the discharge cells in the second line.

The similar address operation is performed sequentially on scan electrode SC3, scan electrode SC4, . . . , scan electrode SCn in this order until the operation reaches the discharge cells in the n-th line.

After all the address operations are completed, by turning off transistor Q63 and turning on transistor Q52 and transistor Q59, the voltage at node A is clamped to voltage 0 (V). Next, by turning off transistor QH1-transistor QHn and turning on transistor QL1-transistor QLn, scan electrode SC1-scan electrode SCn are applied with voltage 0 (V), i.e. the voltage at node A.

Thus, address period Tw1 of subfield SF1 is completed. In address period Tw1, an address discharge is caused selectively in the discharge cells to be lit so as to form wall charge for a sustain discharge in the discharge cells.

Voltage Ve applied to sustain electrode SU1-sustain electrode SUn in the second half of initializing period Ti1 may have a value different from that of voltage Ve applied to sustain electrode SU1-sustain electrode SUn in the address period.

In sustain period Ts1 of subfield SF1, first, voltage 0 (V) is applied to sustain electrode SU1-sustain electrode SUn, and a sustain pulse at positive voltage Vs is applied to scan electrode SC1-scan electrode SCn.

With the application of this sustain pulse, in a discharge cell having undergone an address discharge in address period Tw1, the voltage difference between scan electrode SCi and sustain electrode SUi exceeds the discharge start voltage, and a sustain discharge occurs between scan electrode SCi and sustain electrode SUi. Ultraviolet rays generated by this sustain discharge cause phosphor layer 25 in the discharge cell having undergone the sustain discharge to emit light. With this sustain discharge, negative wall voltage accumulates on scan electrode SCi and positive wall voltage accumulates on sustain electrode SUi. Positive wall voltage also accumulates on data electrode Dk. However, in the discharge cells having undergone no address discharge in address period Tw1, no sustain discharge occurs.

Subsequently, voltage 0 (V) is applied to scan electrode SC1-scan electrode SCn and a sustain pulse at voltage Vs is applied to sustain electrode SU1-sustain electrode SUn. In the discharge cells having undergone the sustain discharge immediately before this voltage application, a sustain discharge occurs again. Negative wall voltage accumulates on sustain electrode SUi and positive wall voltage accumulates on scan electrode SCi.

Similarly, scan electrode SC1-scan electrode SCn and sustain electrode SU1-sustain electrode SUn are alternately applied with sustain pulses equal in number to the luminance weight multiplied by a predetermined luminance magnification. Thus, in the discharge cells having undergone an address discharge in address period Tw1, the sustain discharge occurs at the number of times corresponding to the luminance weight. Therefore, the discharge cells emit light at luminances corresponding to the luminance weight.

Thus, the sustain operation in sustain period Ts1 of subfield SF1 is completed.

Subsequently, scan electrode SC1-scan electrode SCn are applied with an up-ramp waveform voltage that gently rises from voltage 0 (V) to voltage Vr.

A description is provided for the operation of scan electrode driver circuit 33 when the up-ramp waveform voltage is applied to scan electrode SC1-scan electrode SCn.

First, by turning on transistor Q52 and transistor Q59, the voltage at node A is clamped to voltage 0 (V). Next, by turning off transistor QH1-transistor QHn and turning on transistor QL1-transistor QLn, scan electrode SC1-scan electrode SCn are applied with voltage 0 (V), i.e. the voltage at node A.

Next, transistor Q52 is turned off. By feeding a current to transistor Q55 through resistor R55, the Miller integration circuit in up-waveform generation circuit 55 is operated. With this operation, the voltage at node A gently rises from voltage 0 (V) toward voltage Vr. The voltage at node A is applied to scan electrode SC1-scan electrode SCn via transistor QL1-transistor QLn, respectively. Thus, scan electrode SC1-scan electrode SCn can be applied with an up-ramp waveform voltage that gently rises from voltage 0 (V) toward voltage Vr.

The above description shows the operation of scan electrode driver circuit 33 when scan electrode SC1-scan electrode SCn are applied with the up-ramp waveform voltage rising to voltage Vr.

Voltage Vr is set to a voltage exceeding the discharge start voltage. Thereby, while the up-ramp waveform voltage applied to scan electrode SC1-scan electrode SCn is rising above the discharge start voltage, a weak discharge (erasing discharge) continuously occurs between sustain electrode SUi and scan electrode SCi in a discharge cell having undergone a sustain discharge.

The charged particles generated by this weak discharge accumulate on sustain electrode SUi and scan electrode SCi as wall charge so as to reduce the voltage difference between sustain electrode SUi and scan electrode SCi. This reduces the wall voltage on scan electrode SCi and the wall voltage on sustain electrode SUi while the positive wall voltage is left on data electrode Dk. Thus, unnecessary wall charge in the discharge cell is erased.

After the voltage applied to scan electrode SC1-scan electrode SCn has reached voltage Vr, the voltage applied to scan electrode SC1-scan electrode SCn is lowered to voltage 0 (V). Thus, sustain period Ts1 of subfield SF1 is completed.

In this manner, subfield SF1 is completed.

Next, a description is provided for a selective initializing subfield, using subfield SF2 as an example.

In initializing period Ti2 of subfield SF2, voltage 0 (V) is applied to data electrode D1-data electrode Dm, and voltage Ve is applied to sustain electrode SU1-sustain electrode SUn.

Scan electrode SC1-scan electrode SCn are applied with a down-ramp waveform voltage that falls from a voltage lower than the discharge start voltage toward negative voltage Vi with a gradient equal to that of the down-ramp waveform voltage generated in the forced initializing period. Voltage Vi is set to a voltage exceeding the discharge start voltage.

A description is provided for the operation of scan electrode driver circuit 33 when the down-ramp waveform voltage is applied to scan electrode SC1-scan electrode SCn.

First, by turning on transistor Q52 and transistor Q59, the voltage at node A is clamped to voltage 0 (V). Next, by turning off transistor QH1-transistor QHn and turning on transistor QL1-transistor QLn, scan electrode SC1-scan electrode SCn are applied with voltage 0 (V), i.e. the voltage at node A.

Next, transistor Q52 and transistor Q59 are turned off. By feeding a current to transistor Q62 through resistor R62, the Miller integration circuit in down-waveform generation circuit 60 is operated. With this operation, the voltage at node B gently falls from (voltage 0 (V)+voltage Va) toward voltage 0 (V). The voltage at node A gently falls from voltage 0 (V) toward negative voltage (−Va). The voltage at node A is applied to scan electrode SC1-scan electrode SCn via transistor QL1-transistor QLn, respectively. Thus, scan electrode SC1-scan electrode SCn can be applied with a down-ramp waveform voltage that gently falls from voltage 0 (V) toward negative voltage (−Va).

The above description shows the operation of scan electrode driver circuit 33 when scan electrode SC1-scan electrode SCn are applied with the down-ramp waveform voltage in the selective initializing period.

While this down-ramp waveform voltage is applied to scan electrode SC1-scan electrode SCn, a weak initializing discharge occurs between scan electrode SCi and sustain electrode SUi, and between scan electrode SCi and data electrode Dk in the discharge cell having undergone the sustain discharge in sustain period Ts1 of the immediately preceding subfield (subfield SF1 in FIG. 5).

This initializing discharge reduces the negative wall voltage on scan electrode SCi, the positive wall voltage on sustain electrode SUi, and discharges the excess part of the positive wall voltage on data electrode Dk. Thus, the wall voltage in the discharge cells is adjusted to a wall voltage suitable for the address operation in the address period.

In contrast, in the discharge cells having undergone no sustain discharge in sustain period Ts1 of the immediately preceding subfield (subfield SF1), no initializing discharge occurs, and the previous wall voltage is maintained.

The above voltage waveform is a selective initializing waveform for causing an initializing discharge selectively in the discharge cells having undergone an address operation in the address period of the immediately preceding subfield (address period Tw1, herein). The operation of applying the selective initializing waveform to scan electrode SC1-scan electrode SCn is a selective initializing operation.

Thus, a selective initializing operation in the initializing period of subfield SF2, i.e. a selective initializing subfield, is completed.

In address period Tw2 of subfield SF2, the respective electrodes are applied with driving voltage waveforms same as those in address period Tw1 of subfield SF1. Also in subsequent sustain period Ts2, similarly to sustain period Ts1 of subfield SF1, scan electrode SC1-scan electrode SCn and sustain electrode SU1-sustain electrode SUn are applied with sustain pulses corresponding in number to the luminance weight.

In subfield SF3 and subfields thereafter, the respective electrodes are applied with the driving voltage waveforms same as those in subfield SF2 except for the number of sustain pulses generated in the sustain period.

The above description has outlined the driving voltage waveforms applied to the respective electrodes of panel 10 in the exemplary embodiment.

In the exemplary embodiment, examples of the values of voltage applied to the respective electrodes are as follows: voltage Vp=147 (V); voltage Vr=215 (V); voltage Vs=215 (V); voltage Vi=−180 (V); voltage Va=205 (V); voltage Ve=155 (V); and voltage Vd=58 (V). The gradient of the up-ramp waveform voltage is approximately 1.3 V/μsec; the gradient of the down-ramp waveform voltage is approximately −1.5 V/μsec.

However, in the exemplary embodiment, the above voltage values, specific numerical values of the gradients, or the like are only examples. In the present invention, the respective voltage values, gradients, or the like are not limited to the above numerical values. Preferably, the respective voltage values, gradients, or the like are set optimally for the discharge characteristics of the panel, the specifications of the plasma display apparatus, or the like.

In the exemplary embodiment, subfield SF1 is a forced initializing subfield where a forced initializing operation is performed, and the other subfields (subfield SF2 and subfields thereafter) are selective initializing subfields where a selective initializing operation is performed. However, the present invention is not limited to this structure. For example, subfield SF1 may be set as a selective initializing subfield and the other subfields may be set as forced initializing subfields. Alternatively, a plurality of subfields may be set as forced initializing subfields.

In this manner, scan electrode driver circuit 33 of the exemplary embodiment includes scan pulse generation circuit 40, sustain pulse generation circuit 50, up-waveform generation circuit 55, and down-waveform generation circuit 60.

Sustain pulse generation circuit 50 generates sustain pulses by changing the electric potential at node A, i.e. the reference electric potential of scan pulse generation circuit 40, between voltage Vs and voltage 0 (V).

Up-waveform generation circuit 55 generates an up-ramp waveform voltage by gently raising the electric potential at node A toward voltage Vr.

Down-waveform generation circuit 60 generates a down-ramp waveform voltage by gently lowering the electric potential at node A toward negative voltage (−Va).

Scan pulse generation circuit 40 includes first electric power supply E41, transistor QH1-transistor QHn, and transistor QL1-transistor QLn.

First electric power supply E41 superimposes positive voltage Vp on the electric potential at node A.

Transistor QH1-transistor QHn are high-voltage-side transistors for outputting the high-side voltage of first electric power supply E41, i.e. the voltage obtained by superimposing positive voltage Vp on the electric potential at node A, to scan electrode SC1-scan electrode SCn, respectively.

Transistor QL1-transistor QLn are low-voltage-side transistors for outputting the low-side voltage of first electric power supply E41, i.e. the voltage at node A, to scan electrode SC1-scan electrode SCn, respectively.

Down-waveform generation circuit 60 includes transistor Q63, second electric power supply E61, and a Miller integration circuit.

Second electric power supply E61 superimposes voltage Va on the electric potential at node A.

Transistor Q63 has one terminal connected to node B of the high-side voltage of second electric power supply E61 and the other terminal connected to the ground electric potential, i.e. voltage 0 (V). Transistor Q63 clamps the voltage at node A to negative voltage (−Va) by clamping the high-side voltage of second electric power supply E61 to voltage 0 (V).

The Miller integration circuit in down-waveform generation circuit 60 has one terminal connected to node B and the other terminal connected to the ground electric potential, i.e. voltage 0 (V). This Miller integration circuit lowers the electric potential at node A toward negative voltage (−Va) by gently lowering the electric potential at node B toward voltage 0 (V). Thereby, a down-ramp waveform voltage is generated.

In the exemplary embodiment, thus configured down-waveform generation circuit 60 is capable of generating a scan pulse at negative voltage (−Va) and a down-ramp waveform voltage falling toward negative voltage Vi in the state where transistor Q62 in the Miller integration circuit and transistor Q63 connected parallel to transistor Q62 are connected to the ground electric potential instead of an electric power supply for generating a negative voltage. That is, without using the electric power supply for generating a negative voltage, down-waveform generation circuit 60 can be formed with a simple configuration as shown in FIG. 4.

Further, scan electrode driver circuit 33 thus configured allows an overvoltage detection circuit for first electric power supply E41 and second electric power supply E61 to be formed with a simple configuration. The overvoltage detection circuit is a circuit for detecting an overvoltage when the voltage generated by first electric power supply E41 or second electric power supply E61 exceeds a preset voltage. That is, the overvoltage detection circuit is a protection circuit in scan electrode driver circuit 33.

Hereinafter, this overvoltage detection circuit is detailed.

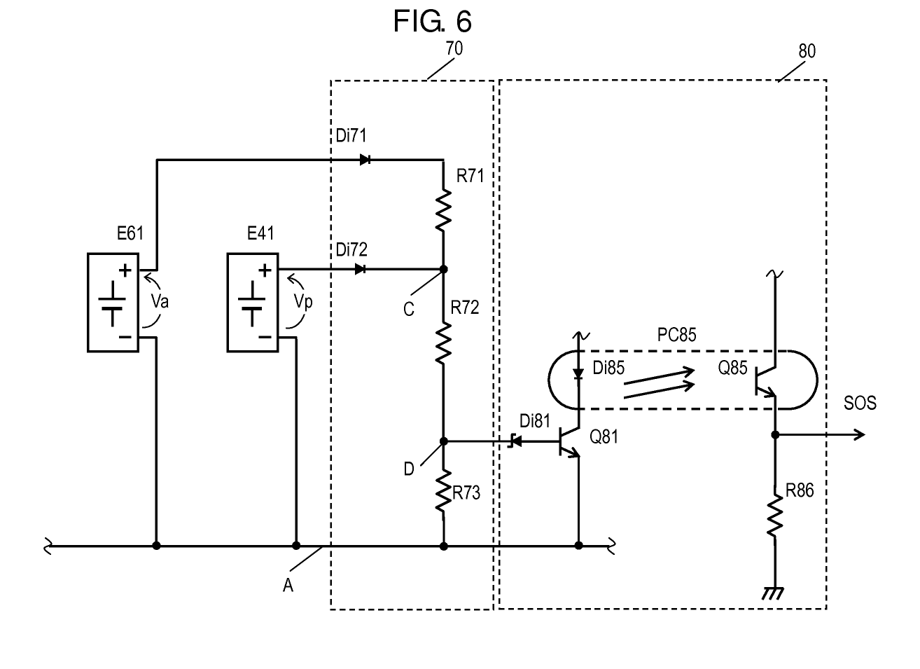

FIG. 6 is a diagram schematically showing a configuration example of the overvoltage detection circuit in scan electrode driver circuit 33 of plasma display apparatus 30 in accordance with the exemplary embodiment of the present invention. FIG. 6 only shows a circuit related to the overvoltage detection circuit, and the other circuits are omitted.

The overvoltage detection circuit shown in FIG. 6 is the overvoltage detection circuit for first electric power supply E41 and second electric power supply E61.

The overvoltage detection circuit includes resistive divider circuit 70 and comparator circuit 80.

Resistive divider circuit 70 includes resistor R71, resistor R72, resistor R73, diode Di71, and diode Di72.

Resistor R71, resistor R72, and resistor R73 are connected in series. One terminal of resistor R73 is connected to node A; the other terminal of resistor R73 is connected to one terminal of resistor R72. Hereinafter, the junction point between resistor R73 and resistor R72 is denoted as “node D”.

The other terminal of resistor R72 is connected to one terminal of resistor R71. The other terminal of resistor R71 is connected, via blocking diode Di71, to the terminal of second electric power supply E61 on the high voltage side. Thus, the voltage obtained by superimposing voltage Va on the voltage at node A is applied to the other terminal of resistor R71. Hereinafter, the junction point between resistor R72 and resistor R71 is denoted as “node C”.

The terminal of first electric power supply E41 on the high voltage side is connected, via blocking diode Di72, to node C, i.e. the junction point between resistor R72 and resistor R71. Thus, the voltage obtained by superimposing voltage Vp on the voltage at node A is applied to node C.

Resistor R71 is connected to the terminal of second electric power supply E61 on the high voltage side; resistor R73 is connected to the terminal of second electric power supply E61 on the low voltage side. Thus, the voltage at node C is a voltage obtained by dividing voltage Va, i.e. the output voltage of second electric power supply E61, by the resistance of resistor R71, resistor R72, and resistor R73. In the exemplary embodiment, the resistance values of resistor R71, resistor R72, and resistor R73 are set such that the voltage at node C is substantially equal to voltage Vp, i.e. the output voltage of first electric power supply E41.

The terminal of first electric power supply E41 on the high voltage side is connected to node C of resistor R72; the terminal of first electric power supply E41 on the low voltage side is connected to resistor R73. Thus, the voltage at node D is a voltage obtained by dividing voltage Vp, i.e. the output voltage of first electric power supply E41, by the resistance of resistor R72 and resistor R73.

Comparator circuit 80 includes Zener diode Di81, transistor Q81, photo coupler PC85, and resistor R86.

The anode of Zener diode Di81 is connected to the base of transistor Q81 and the cathode thereof is connected to node D. The emitter of transistor Q81 is connected to node A, and the collector of transistor Q81 is connected to light-emitting diode Di85 in photo coupler PC85.

When the voltage at node D rises and exceeds the Zener voltage of Zener diode Di81, a current flows from node D, via Zener diode Di81, to the base of transistor Q81. This brings transistor Q81 into the turn-on state. Thus, in transistor Q81, a current flows from the collector to the emitter. A current also flows in light-emitting diode Di85, thereby lighting the light-emitting diode Di85. When light-emitting diode Di85 is lit, a current flows in photo transistor Q85. The voltage (at a high level) generated by the current and resistor R86 is output from comparator 80 as overvoltage detection signal SOS.

Hereinafter, the voltage at node D at which transistor Q81 is brought into the turn-on state is denoted as “threshold voltage”.

As long as the voltage at node D is lower than the “threshold voltage” and does not exceed the Zener voltage of Zener diode Di81, transistor Q81 is not brought into the turn-on state and thus no current flows in photo transistor Q85. As a result, the voltage output from comparator 80 is voltage 0 (V) (at a low level).

In the exemplary embodiment, the resistance values of resistor R71, resistor R72, and resistor R73 are set such that when both voltage Vp output from first electric power supply E41 and voltage Va output from second electric power supply E61 are normal voltages, the voltage at node D does not exceed the Zener voltage of Zener diode Di81 and transistor Q81 is not brought into the turn-on state. Thus, when both of the output voltage of first electric power supply E41 and the output voltage of second electric power supply E61 are normal voltages, the voltage at node D is lower than the “threshold voltage” and overvoltage detection signal SOS output from comparator circuit 80 is at voltage 0 (V) (the low level).

For example, when the output voltage of second electric power supply E61 rises above the normal voltage, blocking diode Di72 works to prevent the backflow of current to first electric power supply E41, and thus the voltage at node D rises. When the voltage at node D exceeds the “threshold voltage”, transistor Q81 is brought into the turn-on state and overvoltage detection signal SOS output from comparator circuit 80 becomes the high level.

Alternatively, when the output voltage of first electric power supply E41 rises above the normal voltage, blocking diode Di71 works to prevent the backflow of current to second electric power supply E61, and thus the voltage at node D rises. When the voltage at node D exceeds the “threshold voltage”, transistor Q81 is brought into the turn-on state and overvoltage detection signal SOS output from comparator circuit 80 becomes the high level.

As described above, when the output voltage of one of first electric power supply E41 and second electric power supply E61 exceeds the normal voltage, the voltage at node D rises. The voltage at node D rises above the “threshold voltage” determined by Zener diode Di81 and transistor Q81, transistor Q81 is brought into the turn-on state. Thus, light-emitting diode Di85 in photo coupler PC85 is lit and photo transistor Q85 is turned on. This makes overvoltage detection signal SOS at the high level.

As described above, scan electrode driver circuit 33 in the exemplary embodiment includes an overvoltage detection circuit for detecting an overvoltage when the output voltage of first electric power supply E41 or second electric power supply E61 becomes the overvoltage. This overvoltage detection circuit divides output voltage Va of second electric power supply E61 by the resistance of resistor R71, resistor R72, and resistor R73 such that the voltage equal to voltage Vp of first electric power supply E41 occurs at node C. Voltage Vp of first electric power supply E41 is connected to node C via diode Di72. The voltage at node D obtained by dividing the voltage at node C by resistance is compared with the predetermined “threshold voltage”.

With this configuration, in scan electrode driver circuit 33, when the output voltage of first electric power supply E41 or second electric power supply E61 becomes an overvoltage, the overvoltage can be detected by one overvoltage detection circuit.

In the exemplary embodiment, since the output voltage (voltage Va) of second electric power supply E61 is higher than the output voltage (voltage Vp) of first electric power supply E41, the resistive divider circuit is configured as shown in FIG. 6. When the output voltage of first electric power supply E41 is higher than the output voltage of second electric power supply E61, the junction point of the output terminal of first electric power supply E41 only needs to be exchanged with the junction point of the output terminal of second electric power supply E61 in the configuration of FIG. 6. Further, the resistance values of resistor R71, resistor R72, and resistor R73 forming the resistive divider circuit only need to be set such that the voltage at node C is equal to the output voltage of second electric power supply E61.

In the exemplary embodiment, the overvoltage detection circuit is configured such that the overvoltage of the output voltage of first electric power supply E41 or the output voltage of second electric power supply E61 is detected by comparing the voltage at node D obtained by dividing the voltage at node C by resistance with the predetermined “threshold voltage”. However, the present invention is not limited to this configuration. For instance, the overvoltage detection circuit may be configured without node D such that the voltage at node C is compared with the “threshold voltage” set for detection of an overvoltage when the voltage at node C becomes the overvoltage.

That is, scan electrode driver circuit 33 in the exemplary embodiment only needs to include an overvoltage detection circuit having the following configuration. The overvoltage detection circuit includes a resistive divider circuit and a comparator circuit. The resistive divider circuit divides the output voltage of one of first electric power supply E41 and second electric power supply E61 having a higher output voltage by resistance so as to generate a voltage equal to the voltage of the electric power supply that has a lower output voltage. In the resistive divider circuit, the output terminal of the electric power supply having the lower output voltage is connected, via a blocking diode, to node C whose voltage is equal to the voltage of the electric power supply having the lower output voltage. The comparator circuit compares the voltage at node C or the voltage at node D obtained by dividing the voltage at node C by resistance with a predetermined “threshold voltage”. The comparator circuit is configured such that when the output voltage of first electric power supply E41 or the output voltage of second electric power supply E61 becomes an overvoltage, overvoltage detection signal SOS becomes a high level. Thus, the overvoltage of first electric power supply E41 or second electric power supply E61 is detected. In this manner, in the exemplary embodiment, the overvoltage of first electric power supply E41 and second electric power supply E61 can be detected by one overvoltage detection circuit.

In plasma display apparatus 30, the reference electric potential in scan electrode driver circuit 33 is the electric potential at node A. The reference electric potential in the circuit for receiving overvoltage detection signal SOS is the ground electric potential (voltage 0 (V)). Thus, the reference electric potential in scan electrode driver circuit 33 is different from the reference electric potential in the circuit for receiving overvoltage detection signal SOS. For this reason, in the exemplary embodiment, comparator circuit 80 includes photo coupler PC85 such that two circuits at different reference electric potentials are coupled via photo coupler PC85.

In the present invention, the number of subfields forming one field, which subfield to be set as a forced initializing subfield, the luminance weight of each subfield, or the like is not limited to the above numerical value. The subfield structure may be switched in response to an image signal, for example.

The driving voltage waveforms of FIG. 5 only show an example in the exemplary embodiment of the present invention, and the present invention is not limited to these driving voltage waveforms.

The circuit configurations of FIG. 3, FIG. 4, and FIG. 6 only show examples in the exemplary embodiment of the present invention, and the present invention is not limited to these circuit configurations.

The specific numerical values shown in the exemplary embodiment of the present invention are set based on the characteristics of panel 10 that has a 50-inch screen and 1024 display electrode pairs 14, and only show examples in the exemplary embodiment. The present invention is not limited to these numerical values. Preferably, each numerical value is set optimally for the specifications of the panel, the characteristics of the panel, the specifications of the plasma display apparatus, or the like. Variations are allowed for each numerical value within the range in which the above advantages can be obtained. The number of subfields forming one field, the luminance weight of each subfield, or the like is not limited to the value shown in the exemplary embodiment of the present invention. The subfield structure may be switched in response to an image signal, for example.

### INDUSTRIAL APPLICABILITY

The present invention can suppress the number of components forming a scan electrode driver circuit, and implement the scan electrode driver circuit with a simple configuration. Thus, the present invention is useful as a plasma display apparatus.

### REFERENCE MARKS IN THE DRAWINGS

10 Panel
11 Front substrate
12 Scan electrode
13 Sustain electrode
14 Display electrode pair
15, 23 Dielectric layer
16 Protective layer
21 Rear substrate
22 Data electrode
24 Barrier rib
25, 25R, 25G, 25B Phosphor layer
30 Plasma display apparatus
31 Image signal processing circuit
32 Data electrode driver circuit
33 Scan electrode driver circuit
34 Sustain electrode driver circuit
35 Timing generation circuit
40 Scan pulse generation circuit
50 Sustain pulse generation circuit
53 Power recovery part
55 Up-waveform generation circuit
60 Down-waveform generation circuit
70 Resistive divider circuit
80 Comparator circuit
C55, C62 Capacitor
R55, R62, R71, R72, R73, R86 Resistor
Di71, Di72 Diode
Di81 Zener diode
Di85 Light-emitting diode
Q85 Photo transistor
PC85 Photo coupler
Q51, Q52, Q55, Q59, Q62, Q63, Q81, QH1-QHn, QL1-QLn Transistor
E41 First electric power supply
E61 Second electric power supply
SOS Overvoltage detection signal
A, B, C, D Node

1. A plasma display apparatus comprising:
a plasma display panel having a plurality of discharge cells, each of the discharge cells including a scan electrode; and
a scan electrode driver circuit for applying a driving voltage waveform to the scan electrodes, the plasma display apparatus displaying an image on the plasma display panel such that one field is formed of a plurality of subfields, each of the subfields having an initializing period, an address period, and a sustain period,
wherein the scan electrode driver circuit includes
a down-waveform generation circuit for generating a down-ramp waveform voltage to be applied to the scan electrodes in the initializing periods; and
a scan pulse generation circuit for generating a scan pulse to be applied to the scan electrodes in the address periods,
the scan pulse generation circuit includes
a first electric power supply for generating a positive voltage to be superimposed on a reference electric potential of the scan pulse generation circuit;
a plurality of high-voltage-side transistors for outputting a high-side voltage of the first electric power supply to the respective plurality of scan electrodes; and
a plurality of low-voltage-side transistors for outputting a low-side voltage of the first electric power supply to the respective plurality of scan electrodes,
the down-waveform generation circuit includes
a second electric power supply for generating a positive voltage to be superimposed on the reference electric potential; and
a Miller integration circuit that has one terminal connected to a high-voltage side of the second electric power supply and an other terminal connected to a ground electric potential, and
the down-waveform generation circuit generates a down-ramp waveform voltage falling to a negative voltage.

2. The plasma display apparatus of claim 1, wherein
the scan electrode driver circuit includes a resistive divider circuit and a comparator circuit,
the resistive divider circuit divides an output voltage of one of the first electric power supply and the second electric power supply having a higher output voltage by resistance so as to generate a voltage equal to a voltage of the electric power supply that has a lower output voltage,
an output terminal of the electric power supply having the lower output voltage is connected, via a blocking diode, to a node whose voltage is equal to the voltage of the electric power supply having the lower output voltage, and
the comparator circuit compares the voltage at the node or an voltage obtained by dividing the voltage at the node by resistance with a predetermined threshold voltage so as to detect an overvoltage of the first electric power supply or the second electric power supply.
